(19) United States
(12) Patent Application Publication
(10) Pub. No.: US 2004/0042104 A1
(43) Pub. Date: Mar. 4, 2004

(54) Method for copying disks, tapes and similar information supports, and corresponding public automatic machine for copying or duplicating information supports

(76) Inventor: Jose Vicente Tarodo Orti, Valencia (ES)

Correspondence Address: Richard M. Goldberg, Suite 419, 25 East Salem Street, Hackensack, NJ, 07601, US

(21) Appl. No.: 10/233,801

(22) Filed: Sep. 3, 2002

(51) Int. Cl. G11B 5/86

(52) U.S. Cl. 360/15

(57) ABSTRACT

A method for copying disks, tapes and similar information supports, and corresponding public automatic machine for copying or duplicating information supports.

This includes the stages of inserting coin/s, token/s or cards (10), reception (11) of one support for reading and another (12) for writing on, the duplication process (13), ejection of the supports (14) and disconnection (15).

The machine includes a supporting cabinet (1), a reading device (2), writing device (4), a device for receiving coins (6), and possibly a control mechanism and viewing screens.

For industrial application in the duplication of supports for storing information and in the production of the corresponding equipment

Method for copying disks, tapes and similar information supports, and corresponding public automatic machine for copying or duplicating information supports.

The technical sector involved in this patent is that of machines for selling products in combination with machines carrying out information treatment.

### STATEMENT OF THE PREVIOUS STATE OF THE ART

There are already many devices known for copying disks or diskettes, which include a computer with input/output peripherals, in which the reading process takes place in one of the peripherals, sending the information on and recording this in the other.

Musical groups often make recordings of demo tapes which they wish to reproduce in small numbers for family and friends or to present these to diffusion media for promotional purposes. These people often do not have household equipment for reproducing this type of supports, so they have to have these made by companies in larger numbers of copies than they actually wanted, and all done at the same time. The invention we are proposing allows these groups or people to make the copies of their disks as the need arises, also avoiding the need for storage of large amounts and the cost involved in this.

This invention covers a method for duplicating disks accessible to the public, as well as the corresponding device for copying or duplicating disks, in particular for CD type disks, which incorporates a control device allowing public use of the copying device, said control device being in particular a mechanism working by means of coins, tokens or credit cards and allowing the equipment to be used by the user for a certain period of time.

In order to make the corresponding explanation clearer, we adjoin a sheet of drawings representing the essence of the present invention in one sheet of drawings.

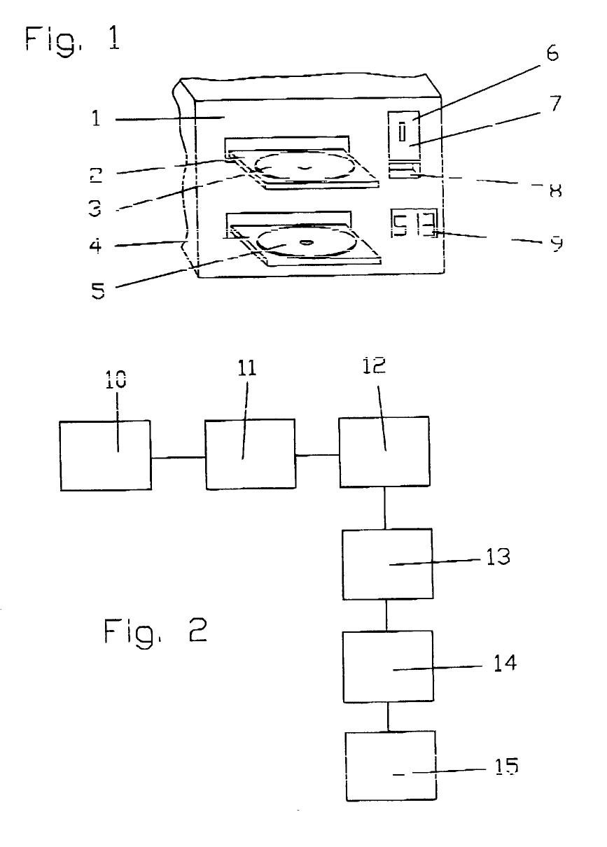

FIG. 1 shows a view of the machine of the invention, and

FIG. 2 shows a diagram of the way this machine works.

You will appreciate in these FIG. 1 indicating a cabinet holding devices as support for disks, tapes or similar, one for reading and another for writing, 2 being a first device or reading device, 3 being the original disk or tape intended to be copied, 4 being a second device or writing device, 5 being the disk, tape, etc. on which the information is to be copied, 6 the coin collection device, 7 being the coin receiver, 8 a device for returning coins as change or for being faulty, and 9 being a display showing messages such as the amount received or to be returned, or the time or amount of information available or left over.

FIG. 2 also shows the process that is being carried out, 10 represents the insertion of a coin, 11 being the request and insertion of an original disk which is to be copied or reproduced, 12 being the request for a blank record on which to copy the information, 13 being the copying process, 14 being the ejection of the devices and 15 the disconnection of the machine.

### EXPLANATION OF ONE FORM OF EMBODIMENT

In accordance with a preferential form of embodiment, the invention refers to a method for copying disks, tapes and similar information supports 3, which works by assigning times or amounts of information to reading 2 and recording 4 devices. This works by means of inserting 10 a coin in a slot 6, then going on to request the original support 11, the target support 12, in such a way that after being positioned the copying process 13 is started, and after finishing both supports are ejected and the system is switched off.

The device is installed in a cabinet 1, which contains the means of reading 2 and those of writing 4, which will respectively house the original 3 and destination supports 4. Furthermore, this device is fitted with a coin mechanism (which can work by tokens or credit or debit cards, or money machine cards), which will show the operation for a particular time depending on the amount assigned. A screen 9 could indicate the status of the information or time available for further copies. Apart from the coin system which assigns times or volumes of copies, there could be further devices allowing the information to be copied to be selected, viewing by means of a screen, or giving some degree of information about the status of the process.

This is for industrial application in the duplication of devices for storage of information and in the production of the corresponding devices.

1.- Method for copying disks, tapes and similar information supports, characterised by involving the following processes:
inserting a coin, token or credit or debit card (10),
inserting mi original device (11),
inserting a destination device (12),
carrying out the copying process in accordance with the parameters selected (13),
ejection of the original and destination disks (14), and,
disconnection of the device (15).

2.- Automatic machine for copying or duplicating information supports, characterised by having the following items:
a support casing (1)
at least one reading device (2) for original disks (3),
at least one writing device (4) for target disks (5),
a coin-receiving device (6),
a message-displaying device.

3.- A machine, according to claim 2, characterised in that the message-displaying device indicates the amount or time assigned or remaining.

4.- A machine, according to claim 2, characterised in that it has a further display device which gives an indication of the status of the copy.

5.- A machine, according to claim 2, characterised in that it has a control mechanism allowing the information that is to be copied to be selected.
